(19) United States
(12) Patent Application Publication
(10) Pub. No.: US 2024/0312038 A1
(43) Pub. Date: Sep. 19, 2024

(54) MULTI-MODE STEREO MATCHING FOR DETERMINING DEPTH INFORMATION

(71) Applicant: QUALCOMM Incorporated, San Diego, CA (US)

(72) Inventors: James Wilson NASH, San Diego, CA (US); Kalin Mitkov ATANASSOV, San Diego, CA (US); Stephen Michael VERRALL, Del Mar, CA (US)

(21) Appl. No.: 18/183,061

(22) Filed: Mar. 13, 2023

(51) Int. Cl. G06T 7/593; H04N 13/239; H04N 13/254

(52) U.S. Cl. CPC G06T 7/593; H04N 13/239; H04N 13/254; H04N 2013/0081

(57) ABSTRACT

Systems and techniques are described for determining disparity information. For instance, a method for determining disparity information is provided. The method including: obtaining a plurality of cost functions; determining a first disparity for a center pixel of a first region of pixels at least in part by comparing one or more minima of a cost function of the center pixel to one or more minima of cost functions of other pixels in the first region; determining a second disparity for the center pixel at least in part by comparing one or more minima of a cost function of a center pixel of a second region to one or more minima of cost functions of other pixels in the second region, including the center pixel of the first region; and determining a third disparity for the center pixel of the first region based on the first disparity and the second disparity.

### FIELD OF THE DISCLOSURE

The present disclosure generally relates to determining depth information. In some examples, aspects of the present disclosure are related to systems and techniques for determining depth information using multi-mode stereo matching, such as by tracking multiple disparity hypotheses when performing stereo matching.

### BACKGROUND OF THE DISCLOSURE

Stereoscopic images of a scene may be used to determine depth information relative to the scene. Stereoscopic images may include two images that are captured substantially simultaneously by two cameras with slightly different views into the scene. Stereoscopic images emulate the slightly different perspectives of a scene captured by a person's two eyes. In addition to providing depth information relative to a scene, stereoscopic images may be used to generate three-dimensional models of the scene. When stereoscopic images are captured by two cameras, the pixels in each of the two images generally correspond to the same objects within the scene, and in many cases, it is possible to correlate a pixel in one image with a pixel in the second image.

### BRIEF SUMMARY

In some examples, systems and techniques are described for determining depth information using multi-mode stereo matching. According to at least one example, a method is provided for determining disparity information. The method includes: obtaining a plurality of cost functions comprising a respective cost function for each pixel of a plurality of pixels of a first image, wherein the respective cost function for each pixel of the plurality of pixels comprises an indication of a similarity, between a window including the pixel and a corresponding window of a second image, as a function of disparity along an epi-polar line in the second image; determining a first disparity for a center pixel of a first region of pixels at least in part by comparing one or more minima of a cost function of the center pixel of the first region to one or more minima of cost functions of other pixels in the first region, the plurality of cost functions comprising the cost function of the center pixel of the first region and the cost functions of the other pixels in the first region; determining a second disparity for the center pixel of the first region at least in part by comparing one or more minima of a cost function of a center pixel of a second region to one or more minima of cost functions of other pixels in the second region, the second region of pixels including the center pixel of the first region, the plurality of cost functions comprising the cost function of the center pixel of the second region and the cost functions of the other pixels in the second region; and determining a third disparity for the center pixel of the first region based on the first disparity of the center pixel of the first region and the second disparity of the center pixel of the first region.

In another example, an apparatus for determining disparity information is provided that includes at least one memory and at least one processor (e.g., configured in circuitry) coupled to the at least one memory. The at least one processor configured to: obtain a plurality of cost functions comprising a respective cost function for each pixel of a plurality of pixels of a first image, wherein the respective cost function for each pixel of the plurality of pixels comprises an indication of a similarity, between a window including the pixel and a corresponding window of a second image, as a function of disparity along an epi-polar line in the second image; determine a first disparity for a center pixel of a first region of pixels at least in part by comparing one or more minima of a cost function of the center pixel of the first region to one or more minima of cost functions of other pixels in the first region, the plurality of cost functions comprising the cost function of the center pixel of the first region and the cost functions of the other pixels in the first region; determine a second disparity for the center pixel of the first region at least in part by comparing one or more minima of a cost function of a center pixel of a second region to one or more minima of cost functions of other pixels in the second region, the second region of pixels including the center pixel of the first region, the plurality of cost functions comprising the cost function of the center pixel of the second region and the cost functions of the other pixels in the second region; and determine a third disparity for the center pixel of the first region based on the first disparity of the center pixel of the first region and the second disparity of the center pixel of the first region.

In another example, a non-transitory computer-readable medium is provided that has stored thereon instructions that, when executed by one or more processors, cause the one or more processors to: obtain a plurality of cost functions comprising a respective cost function for each pixel of a plurality of pixels of a first image, wherein the respective cost function for each pixel of the plurality of pixels comprises an indication of a similarity, between a window including the pixel and a corresponding window of a second image, as a function of disparity along an epi-polar line in the second image; determine a first disparity for a center pixel of a first region of pixels at least in part by comparing one or more minima of a cost function of the center pixel of the first region to one or more minima of cost functions of other pixels in the first region, the plurality of cost functions comprising the cost function of the center pixel of the first region and the cost functions of the other pixels in the first region; determine a second disparity for the center pixel of the first region at least in part by comparing one or more minima of a cost function of a center pixel of a second region to one or more minima of cost functions of other pixels in the second region, the second region of pixels including the center pixel of the first region, the plurality of cost functions comprising the cost function of the center pixel of the second region and the cost functions of the other pixels in the second region; and determine a third disparity for the center pixel of the first region based on the first disparity of the center pixel of the first region and the second disparity of the center pixel of the first region.

In another example, an apparatus for determining disparity information is provided. The apparatus includes: means for obtaining a plurality of cost functions comprising a respective cost function for each pixel of a plurality of pixels of a first image, wherein the respective cost function for each pixel of the plurality of pixels comprises an indication of a similarity, between a window including the pixel and a corresponding window of a second image, as a function of disparity along an epi-polar line in the second image; means for determining a first disparity for a center pixel of a first region of pixels at least in part by comparing one or more minima of a cost function of the center pixel of the first region to one or more minima of cost functions of other pixels in the first region, the plurality of cost functions comprising the cost function of the center pixel of the first region and the cost functions of the other pixels in the first region; means for determining a second disparity for the center pixel of the first region at least in part by comparing one or more minima of a cost function of a center pixel of a second region to one or more minima of cost functions of other pixels in the second region, the second region of pixels including the center pixel of the first region, the plurality of cost functions comprising the cost function of the center pixel of the second region and the cost functions of the other pixels in the second region; and means for determining a third disparity for the center pixel of the first region based on the first disparity of the center pixel of the first region and the second disparity of the center pixel of the first region.

In some aspects, one or more of the apparatuses described herein is, is part of, and/or includes a robot, a drone, a vehicle or a computing system, device, or component of a vehicle, a mobile device (e.g., a mobile telephone and/or mobile handset and/or so-called “smartphone” or other mobile device), an extended reality (XR) device (e.g., a virtual reality (VR) device, an augmented reality (AR) device, or a mixed reality (MR) device), a head-mounted device (HMD) device, a wearable device (e.g., a network-connected watch or other wearable device), a wireless communication device, a camera, a personal computer, a laptop computer, a server computer, another device, or a combination thereof. In some aspects, the apparatus includes a camera or multiple cameras for capturing one or more images. In some aspects, the apparatus further includes a display for displaying one or more images, notifications, and/or other displayable data. In some aspects, the apparatuses described above can include one or more sensors (e.g., one or more inertial measurement units (IMUs), such as one or more gyroscopes, one or more gyrometers, one or more accelerometers, any combination thereof, and/or other sensors).

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative aspects of the present application are described in detail below with reference to the following figures:

FIG. 1 illustrates two images of a single scene captured from different camera positions;

FIG. 2 illustrates two images and an associated cost function;

FIG. 3 includes a graph illustrating a cost function;

FIG. 4 illustrates an image, a region of pixels of the image, and three example cost functions of three respective pixels of region of pixels, according to various aspects of the present disclosure;

FIG. 5 illustrates a first region centered on a pixel and twenty-four additional five-by-five-pixel regions including pixel, according to various aspects of the present disclosure;

FIG. 6 illustrates a system for determining disparities, according to various aspects of the present disclosure;

FIG. 7 illustrates a system for determining depth, according to various aspects of the present disclosure;

FIG. 8 is a flow diagram illustrating another example method for determining depth, according to various aspects of the present disclosure;

FIG. 9 is a diagram illustrating an example of a system for implementing certain aspects of the present disclosure.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and descriptions are not intended to be restrictive.

The ensuing description provides example aspects only and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage, or mode of operation.

Two cameras may be positioned with different perspectives of the same scene and each may capture an image of the scene at substantially the same time. A system may determine depth information for the scene (e.g., a depth map of scene) based on the images captured by the cameras, which can be referred to as stereoscopic images. The depth information may include depths of objects in the scene (e.g., distances between the cameras (or a point relative to the cameras) and the objects).

For example, if a scene captured in stereoscopic images includes an object, a pixel in the image from one camera, which represents a point on the object, may have a corresponding pixel in the image from the second camera that represents the same point on the same object. However, because the images are taken by cameras with different perspectives of the same scene, a position of the pixel corresponding to the point on the object in the first image may be different from a position of the pixel corresponding to the same point on the object in the second image. By matching corresponding pixels in the two images and calculating the distance between these corresponding pixels, it is possible to determine a relative depth of the point of objects within the scene. For example, in some cases, the nearer an object is to the cameras, the greater the distance between corresponding pixels within the images.

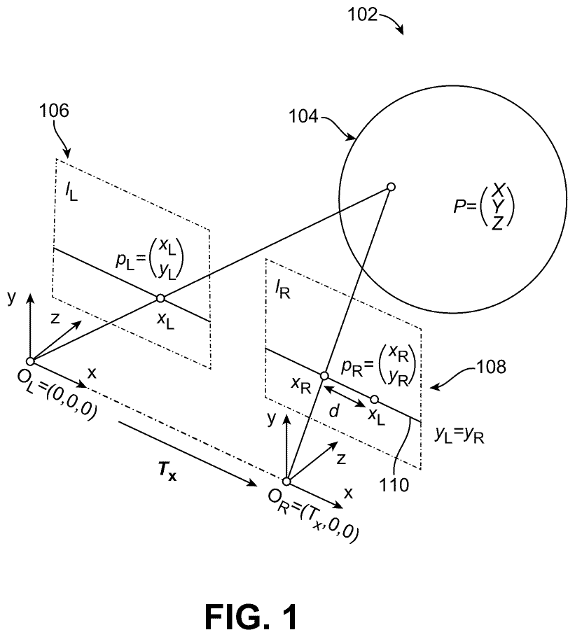

FIG. 1 illustrates two images 106 and 108 (also denoted in FIG. 1 as image I_{L} and image I_{R}) of a single scene 102 captured from different camera positions. The different camera positions are marked as left and right “origin” points, O_{L} and O_{R}, which are offset by a distance Tₓ. Because of the offset Tₓ, the same point P of object 104 appears at different pixel locations p_{L} and p_{R} within the two images 106 (I_{L}) and 108 (I_{R}). As can be seen, the x-axis coordinate x_{R} in the image 108 (I_{R}) corresponding to point P in the image 108 (I_{R}) is offset along epi-polar line 110 by disparity d from a coordinate x_{L}, where the coordinate x_{L} corresponds to the position of the point P in the image 106 (I_{L}). This disparity in pixel locations (also referred to as discrepancy) may be used to determine an approximate distance from the cameras to the point P on object 104 in scene 102. By knowing the stereo camera geometry and applying such an analysis to each point in the images, a depth map of the scene may be generated.

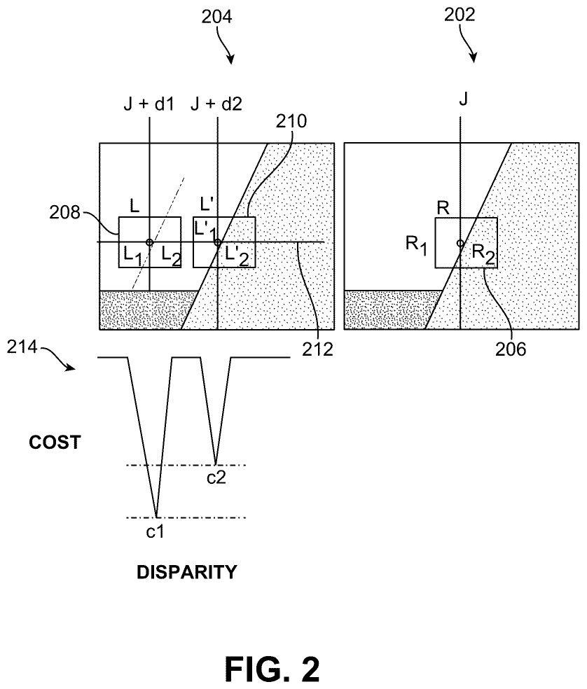

In order to determine the disparity d, a system may determine that the pixel location p_{R} in the image 108 (I_{R}) corresponds to the pixel location p_{L} in the image 106 (I_{L}), for example, by comparing a window of pixels including pixels at, and around, the pixel location p_{L} to a number of windows of pixels in the image 108 (I_{R}). An example of such a window-based comparison technique is described with respect to FIG. 2 below. For example, the system may determine epi-polar line 110 in the image 108 (I_{R}). Epi-polar line 110 may be a defined by a ray projected from origin point O_{L} to the point P as viewed in in the image 108 (I_{R}). The system may compare the window of pixels including pixels at, and around, the pixel location p_{L} to similarly-sized windows along epi-polar line 110.

FIG. 2 illustrates two images, including image 202 (which may be a “right image” or a “reference image”) and image 204 (which may be a “left image”), and an associated cost function 214. To compare windows between images, a window 206 of pixels from the image 202 may be selected. The window 206 of pixels from the image 202 may be compared to one or more windows of pixels from the image 204. In some cases, the window 206 may be compared to similarly-sized windows (e.g., all similarly-sized windows) along an epi-polar line 212 of image 204.

The cost function 214 shown in FIG. 2 is representative of a similarity between window 206 and similarly-sized windows along epi-polar line 212 of image 204 as a function of disparity. The similarity between windows may be based on similarities between respective red, green, blue, and/or intensity (or brightness or luminance) values of pixels included in the respective windows. The lower the value of cost function 214 for a particular disparity, the higher the degree of similarity is between window 206 and a window of image 204 at the corresponding disparity. For example, cost function 214 includes two minima, c1 and c2. The minima c1 corresponds to a disparity d1, which corresponds to a comparison between window 206 and candidate window 208 of image 204. The minima c2 corresponds to a disparity d2 which corresponds to a comparison between window 206 and candidate window 210 of image 204.

A disparity map may be a two-dimensional map of disparities. The two-dimensional map may relate to an image (e.g., image 106 of FIG. 1). For instance, a two-dimensional disparity map may include a resolution that is the same (or substantially the same in some cases) as a corresponding image, with a respective disparity value for each pixel of the image. In one illustrative example, a disparity map may be generated by determining a respective disparity for each pixel of a number of pixels (e.g., all, or most, of the pixels) of an image (e.g., by scanning windows across epi-polar lines of a stereoscopically-paired image and determining a disparity for each of the number of pixels). Each value of the disparity map may represent a disparity (e.g., disparity d of FIG. 1). A depth map may be derived from a disparity map based on the three-dimensional geometry of a scene (e.g., scene 102 of FIG. 1) including a distance between the cameras which captured the images (e.g., the distance T_{X} of FIG. 1).

A depth map may be a representation of three-dimensional information (e.g., depth information). For example, a depth map may be a two-dimensional map of values (e.g., pixel values) representing depths. The values of the depth map may correspond to pixels in a corresponding image (e.g., image 106 of FIG. 1). For instance, the depth map may have a resolution that is the same or substantially the same as the corresponding image, with each depth value of the depth map representing a depth, or distance, between an origin point (e.g., origin point O_{L} of FIG. 1) and points (e.g., point P of FIG. 1). In some cases, each pixel in the depth map may have one depth value. Because a depth map is based on a disparity map, in some cases, each pixel of a disparity may have one disparity.

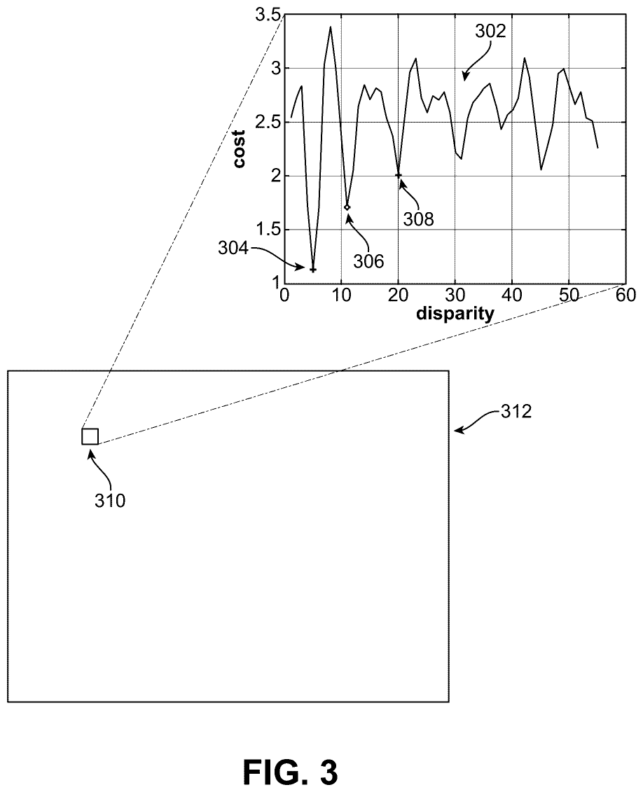

FIG. 3 includes a graph illustrating a cost function 302 corresponding to a pixel 310 of an image 312. Cost function 302 is illustrated as costs (where low cost is indicative of a high degree of similarity between a window and a reference window) as a function of disparity. Cost function 302 includes several minima (which may also be referred to as troughs), including minimum 304, minimum 306, and minimum 308. Minimum 304 may be a referred to as a “lowest minimum” or a “first minimum.” Minimum 306 may be referred to as a “second-lowest minimum” or as a “second minimum.” Minimum 308 may be referred to as a “third-lowest minimum” or as a “third minimum.” In the present disclosure, ordinal references to minima may be related to an order of the values of the minima. For example, a lowest minimum may be referred to as a “first minimum” and a second-lowest minimum may be referred to as a “second minimum,” etc.

One example of an approach for determining a disparity for a pixel of an image is to determine that the lowest minimum of a cost function of the pixel corresponds to the disparity of the pixel. In one illustrative example of determining a disparity using such an approach, a system may select a disparity corresponding to minimum 304 as the disparity of pixel 310 because minimum 304 is the lowest minimum among the minimums 304, 306, and 308 of the cost function 302 of pixel 310.

However, in some cases, the above-described approach may not result in selection of the most appropriate minimum and corresponding disparity for each of the pixels, resulting in incorrect depth information. For example, such an approach may frequently select incorrect disparities for thin objects (e.g., objects that are smaller in the images than a window width, such as a width of the window 206 of FIG. 2). For example, a window including pixels representative of a thin object may include fewer pixels representative of the thin object than pixels not representative of the object (e.g., background pixels). Thus, when comparing windows, such a window may be just as, or more, similar to windows including background pixels than to windows including the thin object. Thus, the above-described approach of using the lowest minimum may result in determining a disparity that corresponds to the background rather than to the thin object.

The present disclosure describes systems, apparatuses, methods (also referred to herein as processes), and computer-readable media (collectively referred to as “systems and techniques”) for determining depth information using multi-mode stereo matching. In contrast to existing approaches, the systems and techniques may further analyze cost functions before selecting a minimum (e.g., the lowest minimum or another minimum) of a cost function to determine a disparity for a pixel. In some cases, the further analysis may result in selecting a minimum that is not the lowest minimum to determine the disparity for the pixel. For example, in some situations, the systems and techniques may select the minimum 306 or the minimum 308 of the cost function 302 of FIG. 3 to determine the disparity of the pixel, rather than only selecting the minimum 304 to determine the disparity of the pixel.

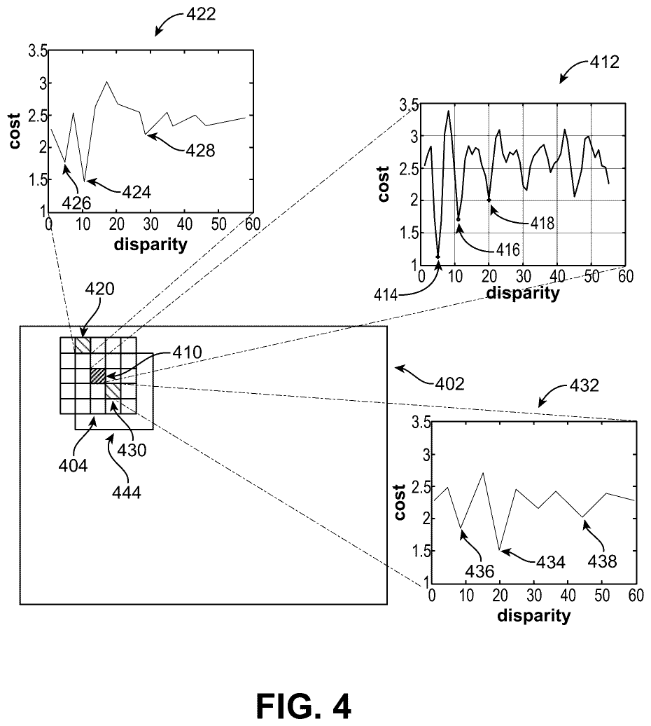

The systems and techniques may compare each cost function of each pixel of a region of pixels to a cost function of a center pixel of the region. For example, FIG. 4 illustrates an image 402, a region of pixels 404 of image 402, and three example cost functions 412, 422, and 432 of three respective pixels 410, 420, and 430 of region of pixels 404. Systems and techniques may segment the region (e.g., region of pixels 404) by determining whether each pixel in region belongs to a foreground or a background, with respect to the region. For example, the systems and techniques may compare a value of one or more respective minima (e.g., the second minimum, such as minimum 426 of cost function 422 and minimum 436 of cost function 432) of each cost function of each pixel of the region to one or more minima of cost function (e.g., the second minimum 416 of cost function 412) of a center pixel (e.g., pixel 410) of the region. Based on the comparison, systems and techniques may correlate each pixel of the region to a minimum of the cost function of the center pixel. For example, based on a relationship between second minimum 426 of cost function 422 and first minimum 414 of cost function 412, the systems and techniques may correlate pixel 420 with first minimum 414. Relating pixels of the region to minima of the cost function of the center pixel of the region may effectively segregate the region according to disparities (which relate to distances) which may include determining whether each pixel in region belongs to a foreground or a background, with respect to the region.

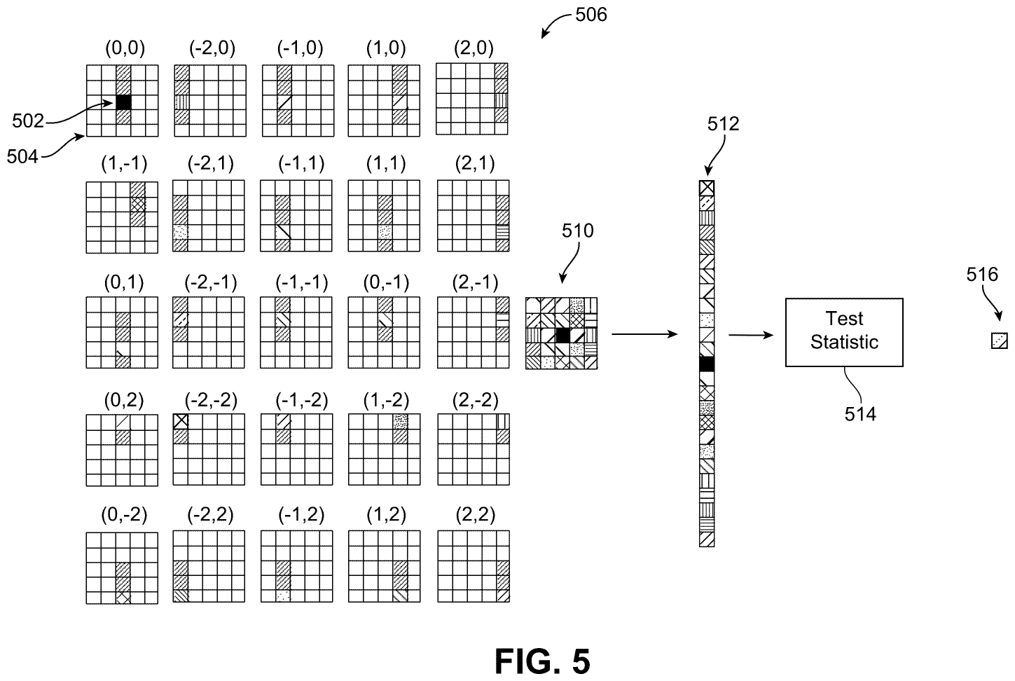

Additionally, the systems and techniques may compare each cost function of each pixel of other regions (the other regions also including the center pixel of the region) to the respective center pixels of the other regions. For example, a second region of pixels 444, centered on pixel 430, may be identified. Pixel 410 may be in second region of pixels 444. Cost functions of each pixel of second region of pixels 444 may be compared to cost function 432 of pixel 430. As another example, FIG. 5 illustrates a first region 504 centered on a pixel 502 and twenty-four additional five-by-five-pixel regions 506 including pixel 502 at different positions within each respective region (e.g., based on regions 506 being centered on other pixels). Regions 506 are each labelled by a respective offset value corresponding to an offset (e.g., a number of pixels in an x direction and a number of pixels in a y direction) of the center position of the respective regions 506 from pixel 502. The respective cost function of the pixel 502 in each of the regions 506 may be compared to the respective cost function of the center pixel of each of the respective regions 506. Based on the comparisons, systems and techniques may correlate the pixel 502 in each of the respective regions 506 to respective minima of the cost function of the center pixels of the respective regions 506.

Because regions 506 include pixel 502, the systems and techniques may correlate pixel 502 to minima of cost functions of center pixels of regions 506. For example, pixel 502 may be correlated with a minimum of each cost function of the respective center pixels of each of regions 506. In this way, pixel 502 may be correlated with multiple minima (e.g., one minimum for region 504 and one respective minimum for each of regions 506). Minima 510 illustrates the multiple minima associated with pixel 502. Minima 510 includes one minimum from each of regions 506 and a respective minimum from each region of the region 504. Ordered minima 512 illustrates minima 510 arranged in a one-dimensional format (e.g., from a greatest value to a least value or from a least value to a greatest value). The systems and techniques may select a minimum 516 from minima 510 (or from ordered minima 512) as the minimum for pixel 502 based on a test statistic 514. Test statistic 514 may be, for example, a mean or average of minima 510, a median of ordered minima 512, or other statistic based on minima 510 and/or ordered minima 512. Minima 516 may be related to a disparity (e.g., based on the cost function from which minima 516 was derived). Minimum 516 (and the corresponding disparity) for pixel 502, selected based on the analysis of the multiple minima, may be more appropriate than other minima (and other corresponding disparities) determined by existing techniques, which may select the lowest minima of the cost function of the pixel as the minimum for a pixel.

In some cases, the first and second images may be captured passively (e.g., without the scene being illuminated by the device capturing the image). In other cases, a scene may be illuminated by the device capturing the images. In some cases, the device capturing the images may illuminate the scene using patterned illumination (e.g., applying different intensities of illumination to different portions of the scene, for example, in a checkerboard pattern) to improve contrast between objects that are close to the device and objects that are distant from the device. In some cases, the device may illuminate the scene by emitting electromagnetic radiation (e.g., light, infrared radiation, etc.) having a specific carrier frequency. In such cases the captured images can be bandpass filtered (the passband based on the specific carrier frequency). The systems and techniques may be applied to images captured according to any of these, or other cases, to improve the detection of disparities when comparing pixels between the images. In cases where the images are bandpass filtered, the bandpass filtering may affect edge-detection (e.g., because the bandpass filtering may remove high-frequency content of the images). The systems and techniques may be useful in such cases to improve disparity selection which may improve edge detection.

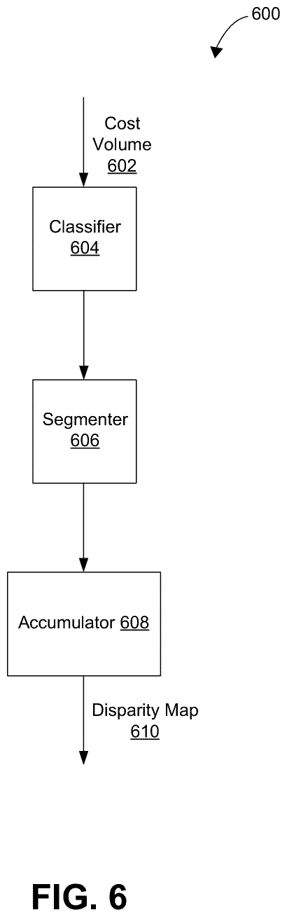

FIG. 6 illustrates a system 600 for determining disparities, according to various aspects of the present disclosure. System 600 may include a classifier 604, a segmenter 606, and an accumulator 608.

System 600 may receive a cost volume 602 as an input. Cost volume 602 may include a respective cost function for each pixel of a plurality of pixels of an image. Each cost function may be for a pixel and may be, or may include, an indication of a similarity between a window including the pixel and a corresponding window of another image as a function of disparity along an epi-polar line in the other image. For example, cost volume 602 may be or may include a cost function (e.g., cost function 214 of FIG. 2, cost function 302 of FIG. 3, cost function 412 of FIG. 4, cost function 422 of FIG. 4, or cost function 432 of FIG. 4) for one or more (and in some cases all) pixels an image (e.g., image 108 of FIG. 1). Each of cost functions may have been determined by comparing a window (e.g., window 206 of FIG. 2) of the image to windows of another image (e.g., candidate window 208 and candidate window 210 of FIG. 2) along an epi-polar line (e.g., epi-polar line 110 of FIG. 1 or epi-polar line 212 of FIG. 2) of the other image. Cost volume 602 may be, or may include, a four-dimensional matrix with dimensions including: image height, image width, disparity, and cost.

Classifier 604 may receive cost volume 602 and may identify pixels of the image from which cost volume 602 was derived that have ambiguous cost functions (which may be referred to herein as “ambiguous pixels”). For example, classifier 604 may identify cost functions of cost volume 602 that may result in the selection of incorrect disparities.

For example, classifier 604 may identify cost functions including multiple minima, one of which may be the correct disparity and others of which may be incorrect. Classifier 604 may identify cost functions based on values of one or more minima relative to a value of a lowest minimum, a cost difference between local minima and first, second, third, etc. minima, prominence (e.g., how prominent/pronounced the minimum is, such as based on cost values on either side of the minimum), any combination thereof, and/or other factors. In some cases, when identifying the cost function, there may be a bias towards nearness (e.g., larger disparities). Classifier 604 may detect multiple local minima by analyzing the relative values of the cost functions (e.g., by thresholding the difference or ratio, computing a peak prominence measure (which may determine the quality of the match at a given shift), and various heuristically-determined cues such as the spacing between local minima, the total variability of the waveform relative to its mean value, and a bidirectional search around the global minimum).

In some cases, the classifier 604 can be optional in the system 600. For example, in cases where the system 600 includes the classifier 604, the classifier 604 may select pixels for further analysis by the segmenter 606. In other cases, system 600 may not include classifier 604, in which case the segmenter 606 may analyze pixels (e.g., all pixels) of an image.

Segmenter 606 may receive cost volume 602 (or a subset of cost volume 602, e.g., as selected by classifier 604), and may determine multiple minima (and/or multiple corresponding disparities) for pixels of the image. For example, segmenter 606 may compare a value of a respective second (and/or third, and/or fourth, etc.) minimum (e.g., second minimum 426, second minimum 436, third minimum 428, and/or third minimum 438, all of FIG. 4) of each cost function (e.g,. cost function 422 of FIG. 4 and/or cost function 432 of FIG. 4) of each pixel of a region (e.g., region 440) to the second (and/or third, and/or fourth, etc.) minimum (e.g., first minimum 414, second minimum 416 and/or third minimum 418, etc., all of FIG. 4) of a center pixel (e.g,. pixel 410 of FIG. 4) of the region. Based on the comparison, segmenter 606 may correlate each pixel of the region (e.g., each pixel of region of pixels 404) to a minimum of the cost function of the center pixel (e.g., first minimum 414, second minimum 416 and/or third minimum 418, etc. of cost function 412).

Additionally, segmenter 606 may compare each cost function of each pixel of other regions (the other regions also including the center pixel of the region) (e.g., region of pixels 444 of FIG. 4 or regions 506 of FIG. 5) to the respective center pixels of the other regions (e.g., pixel 430 of FIG. 4). Based on the comparisons, segmenter 606 may correlate each of the pixels of the respective other regions (e.g., region of pixels 444 or regions 506) to respective minima of the cost function of the center pixels of the respective other regions (e.g., pixel 430). Because the other regions (e.g., region of pixels 444 or regions 506) include the center pixel of the region (e.g., pixel 410 or pixel 502), segmenter 606 may correlate the center pixel of the region (e.g., pixel 410 of pixel 502) to minima of other cost functions of center pixels (e.g., pixel 430) of other regions (e.g., region of pixels 444 or regions 506). In this way, the center pixel of the region (e.g., pixel 410 or pixel 502) may be correlated with multiple minima.

Segmenter 606 may map a surrounding neighborhood (e.g., region) of each ambiguous pixel (e.g., pixels identified by classifier 604, which may have an ambiguous cost function) to either a foreground (which will contain small objects) and the background (which may be the dominant, but erroneous, disparity of the window).

In some cases, the mapping by the segmenter 606 may be an iterative process, in that once segmentation is performed, knowledge of which pixels in the window belong to each minima may be obtained. The cost function of the pixel can then be recomputed based on the knowledge of which pixels in the window belong to each minima (which may represent a more accurate region association). For example, initially, segmenter 606 may map each pixel of a window a disparity. Based on these initial results, segmenter 606 may recompute cost using a subset of pixels when recomputing the cost. For example, a disparity for a pixel may be recomputed based on pixels having the same disparity as the pixel.

In some cases, segmenter 606 may operate on an unfiltered cost volume which is not affected by low pass filtering.

Segmenter 606 may generate a test statistic based on a comparison between the first and second lowest (or any arbitrary number of) minima in a local neighborhood. Cost values may be compared to the test statistic to separate the local pixels into either a foreground label or background label. By recomputing the cost based on the updated knowledge of segmentation, this process can be iterated to improve and refine the segmentation results.

Accumulator 608 may receive multiple minima for one or more pixels (e.g., as determined by segmenter 606) and/or cost volume 602. Accumulator 608 may determine a minimum (and, in some cases, a corresponding disparity) for each pixel. Accumulator 608 may select a minimum (and a corresponding disparity) for each pixel based on a test statistic, such as, for example, a mean of the multiple minima, a median of the multiple minima, any combination thereof, and/or other test statistic.

Accumulator 608 may determine the correct local minimum (but not necessarily a global minimum), and output the correct disparity value. Accumulator 608 may shift and aggregate adjacent overlapping local windows relative to the reference window including the center pixel to produce a more accurate and/or less noisy second minimum disparity map. Since each shifted window is correlated to the reference window, this information can be used to detect and eliminate incorrect segmentation results. Accumulator 608 may generate a disparity map 610.

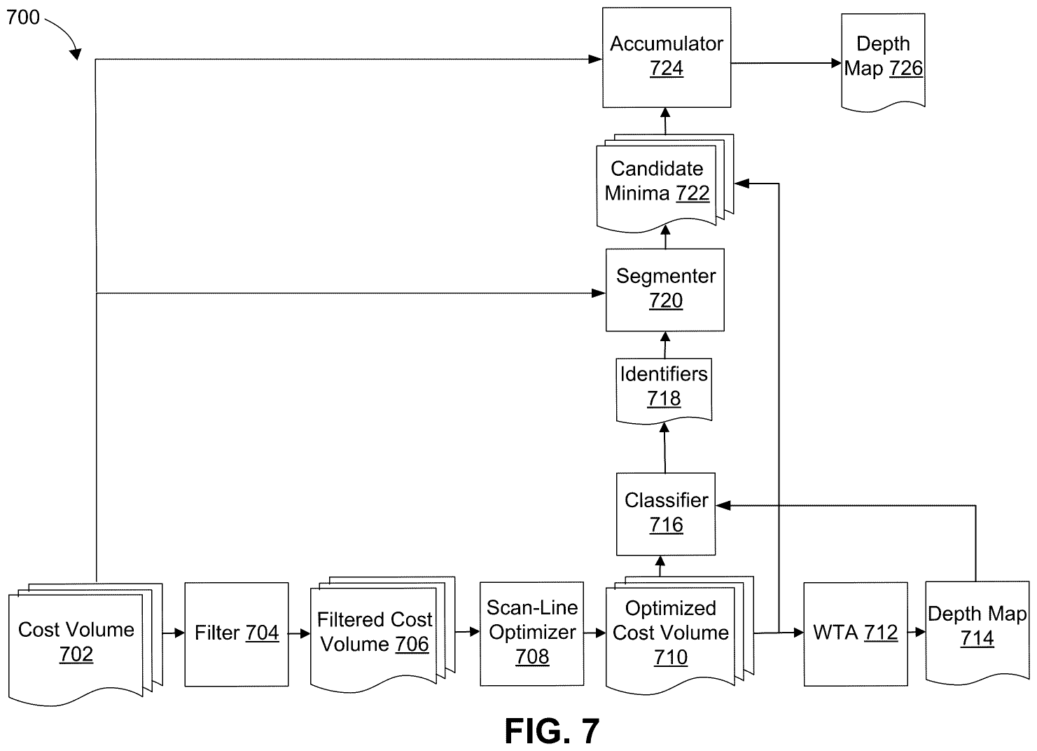

FIG. 7 illustrates a system 700 for determining depth, according to various aspects of the present disclosure. System 700 may include a filter 704, a scan-line optimizer 708, a winner-take-all algorithm 712 (WTA 712), a classifier 716, a segmenter 720, and an accumulator 724.

System 700 may receive a cost volume 702. Cost volume 702 may be the same as, or substantially similar to cost volume 602 of FIG. 6.

Filter 704 may filter cost volume 702 to produce filtered cost volume 706. Filter 704 may be a 5×5 low-pass filter. Cost values computed based on single pixels may be noisy. Filtering (and/or aggregation, which may be part of filtering) at filter 704 may reduce the noise by computing the cost over many pixels and then averaging.

Scan-line optimizer 708 may optimize filtered cost volume 706 to produce optimized cost volume 710. Scanline optimization may be used as a constraint to guide the selection of the correct disparity. The constraints may penalize large disparity changes, such as based on many images being composed of smooth regions, with a few large jumps at object boundaries.

WTA 712 may select a disparity for each pixel of optimized cost volume 710. WTA 712 may select the lowest minimum of the cost function of each pixel to determine the disparity of the pixel. WTA 712 (or another element not illustrated in system 700) may calculate a depth based on each of the disparities of each of the respective pixels to produce depth map 714 (alternatively, depth map 714 may be a disparity map).

Classifier 716 may be the same as, substantially similar to, and/or perform the same, or some of the same, operations as classifier 604 of FIG. 6. For example, classifier 716 may receive optimized cost volume 710 and depth map 714 as input and may identify pixels of optimized cost volume 710 (or of depth map 714) that may have an ambiguous cost. Classifier 716 may provide identifiers 718 indicative of pixels of cost volume 702 that have an ambiguous cost. As with classifier 604 of system 600, classifier 716 is optional in system 700.

Segmenter 720 may be the same as, substantially similar to, and/or perform the same, or some of the same, operations as segmenter 606 of FIG. 6. For example, segmenter 720 may identify multiple candidate minima 722 for each of one or more pixels of cost volume 702. In some cases, segmenter 720 may identify multiple candidate minima 722 for pixels identified by classifier 716 as having an ambiguous cost (e.g., as indicated by identifiers 718). Segmenter 720 may identify candidate minima 722 based on cost volume 702, and not based on optimized cost volume 710. Segmenter 720 may provide candidate minima 722 to accumulator 724.

Accumulator 724 may be the same as, substantially similar to, and/or perform the same, or some of the same, operations as accumulator 608 of FIG. 6. For example, accumulator 608 may determine one minimum for each pixel of cost volume 702. Accumulator 724 may determine the minimum based on cost volume 702 rather than optimized cost volume 710, for example because the low-pass filtering (e.g., of filter 704) may reduce the fidelity of the data (e.g., through the averaging (smoothing) process).

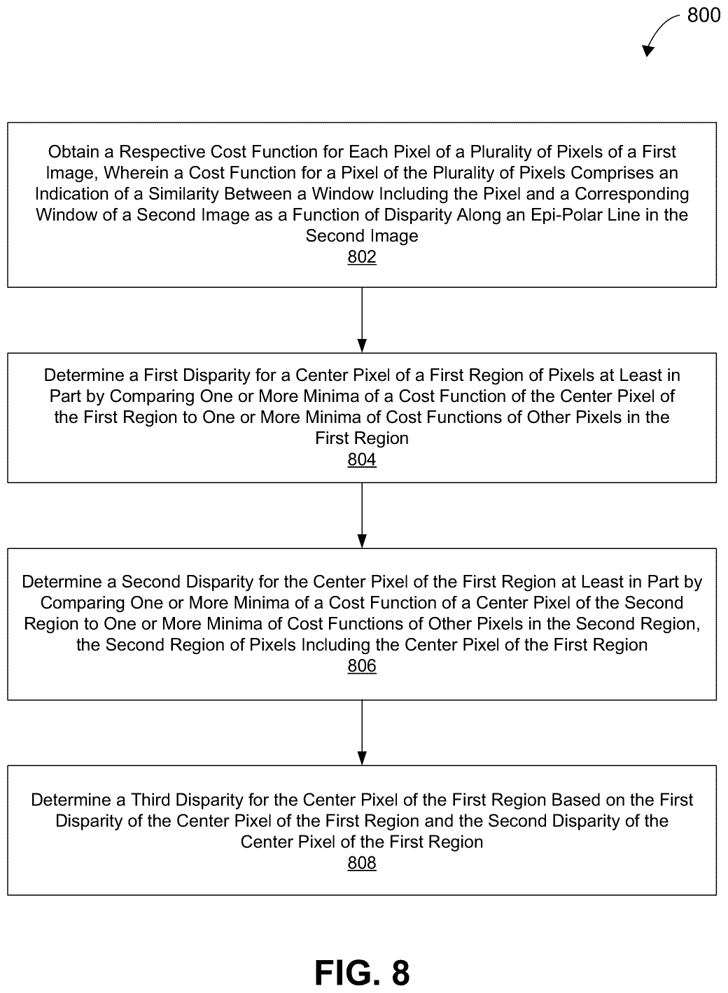

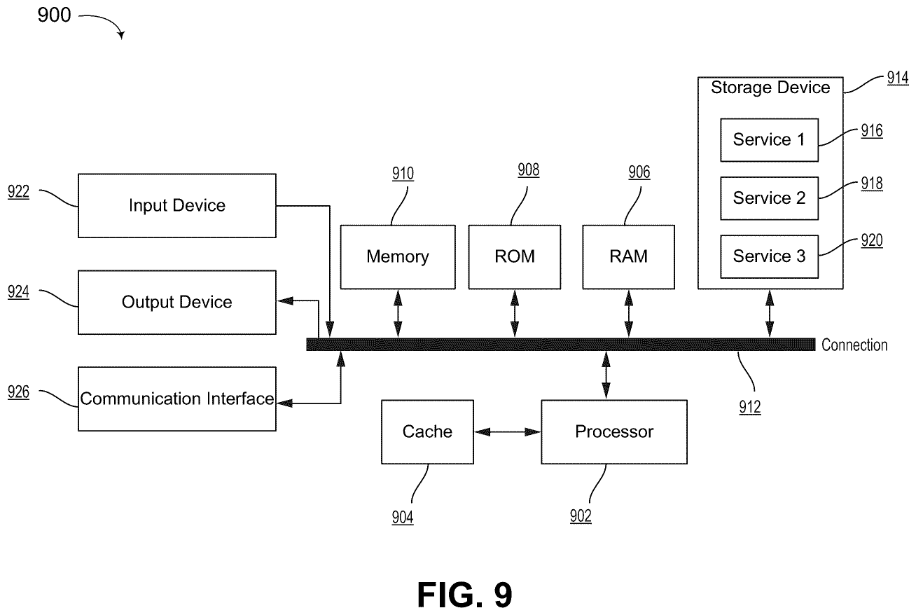

Based on the identified minima of each pixel of the pixels, accumulator 724 (or another element not illustrated in system 700) may calculate a depth based on each of the disparities of each of the respective pixels to produce depth map 726. FIG. 8 is a flow diagram illustrating another example process 800 for determining depth information, according to various aspects of the present disclosure. Process 800 may be performed by a computing device (or apparatus) or a component (e.g., a chipset, one or more processor(s), one or more memory, any combination thereof, or other component) of the computing device. The computing device can be a mobile device (e.g., a mobile phone), a network-connected wearable such as a watch, an extended reality (XR) device (e.g., a virtual reality (VR) device or augmented reality (AR) device), a vehicle or component or system of a vehicle, a camera device, or other type of computing device. In some cases, the process 800 can be performed by the computing device implementing system 600 of FIG. 6 and/or system 700 of FIG. 7. The operations of the process 800 may be implemented as software components that are executed and run on one or more processors (processor 902 of FIG. 9, or other processor(s)). Further, the transmission and reception of signals by the computing device in the process 800 may be enabled, for example, by one or more antennas, one or more transceivers (e.g., wireless transceiver(s)), and/or other communication components (e.g., the communication interface 926 of FIG. 9 or other antennae(s), transceiver(s), and/or component(s)).

In some aspects, process 800 may include illuminating a scene, capturing the first image of the scene at a first image sensor, and capturing the second image of the scene at a second image sensor. There may be a known offset between the first image sensor and the second image sensor, (e.g., offset Tx of FIG. 1). In some aspects, illuminating the scene may include emitting electromagnetic radiation having a carrier frequency. The first image may be filtered using a filter having a passband based on the carrier frequency and the second image may be filtered using the filter.

At block 802, a computing device (or one or more components thereof) may obtain a plurality of cost functions comprising a respective cost function for each pixel of a plurality of pixels of a first image, wherein the respective cost function for each pixel of the plurality of pixels comprises an indication of a similarity, between a window including the pixel and a corresponding window of a second image, as a function of disparity along an epi-polar line in the second image. For example, system 600 of FIG. 6 may obtain cost volume 602 of FIG. 6 and/or system 700 of FIG. 7 may obtain cost volume 702. Cost function 214 of FIG. 2, cost function 302 of FIG. 3, cost function 412 of FIG. 4, cost function 422 of FIG. 4, and cost function 432 of FIG. 4 are examples of cost functions of the plurality of cost functions obtained at block 802. For example, cost function 214 is indicative of a similarity between window 206 and of image 202 and a plurality of windows (including candidate window 208 and candidate window 210) along epi-polar line 212.

In some aspects, the computing device (or one or more components thereof) may determine a first region based on determining a center pixel of the first region is associated with an ambiguous cost function based on one or more factors. In some aspects, the one or more factors comprise at least one of a cost-difference between lowest minima of the cost function or a disparity-difference between the lowest minima of the cost function. For example, classifier 604 of FIG. 6 and/or classifier 716 of FIG. 7 may select the first region based on the cost function of the center pixel of the center region. For instance, classifier 604 and/or classifier 716 may select the region surrounding and including pixel 310 based on cost function 302 (e.g., based on cost differences between one or more of minimum 304, minimum 306 and/or minimum 308 and/or based on disparity differences between minimum 304, minimum 306, and/or minimum 308).

At block 804, the computing device (or one or more components thereof) may determine a first disparity for a center pixel of a first region of pixels at least in part by comparing one or more minima of a cost function of the center pixel of the first region to one or more minima of cost functions of other pixels in the first region, the plurality of cost functions comprising the cost function of the center pixel of the first region and the cost functions of the other pixels in the first region. For example, segmenter 606 of FIG. 6 and/or segmenter 720 of FIG. 7 may determine the first disparity for pixel 410 (e.g., the center pixel of region 404) by comparing one or more minima of cost function 412 with one or more minima of cost functions of other pixels (e.g., pixel 420, pixel 430, etc.) of region pixels 404. For instance, segmenter 606 of FIG. 6 and/or segmenter 720 of FIG. 7 may compare one or more minima of cost function 412 (e.g., first minimum 414, second minimum 416, third minimum 418, etc.) with one or more minima of cost function 422 (e.g., first minimum 424, second minimum 426, third minimum 428, etc.) and/or with one or minima of cost function 432 (e.g., first minimum 434, second minimum 436, third minimum 438, etc.).

In some aspects, block 804 may include comparing a second minimum of the cost function of the center pixel of the first region to a second minimum of each of the cost functions of the other pixels in the first region. For example, segmenter 606 of FIG. 6 and/or segmenter 720 of FIG. 7 may compare second minimum 416 of cost function 412 of pixel 410 to the respective second minima of the respective cost functions of other pixels of region pixels 404 (e.g., second minimum 426 of the cost function 422 of pixel 420 and to second minimum 436 of the cost function 432 of pixel 430).

In some aspects, block 804 may include identifying the first disparity for the center pixel of the first region of pixels based on determining whether a second minimum of each of the cost functions of the other pixels in the first region is less than a second minimum of the cost function of the center pixel of the first region. For example, segmenter 606 of FIG. 6 and/or segmenter 720 of FIG. 7 may determine whether each of the respective second minima of the respective cost functions of other pixels of region pixels 404 (e.g., second minimum 426 of the cost function 422 of pixel 420 and to second minimum 436 of the cost function 432 of pixel 430) is less than second minimum 416 of the cost function 412 of pixel 410.

At block 806, the computing device (or one or more components thereof) may determine a second disparity for the center pixel of the first region at least in part by comparing one or more minima of a cost function of a center pixel of a second region to one or more minima of cost functions of other pixels in the second region, the second region of pixels including the center pixel of the first region, the plurality of cost functions comprising the cost function of the center pixel of the second region and the cost functions of the other pixels in the second region. For example, segmenter 606 and/or segmenter 720 may determine the second disparity for pixel 410 by comparing one or more minima of cost function 432 (the cost function of pixel 430, the center pixel of region 444) with one or more minima of cost functions of other pixels of region pixels 444 (the other pixels of region 444 including pixel 410). For instance, segmenter 606 of FIG. 6 and/or segmenter 720 of FIG. 7 may compare one or more minima of cost function 432 (e.g., first minimum 434, second minimum 436, third minimum 438, etc.) with one or more minima of cost function 412 (e.g., first minimum 414, second minimum 416, third minimum 418, etc.).

At block 808, the computing device (or one or more components thereof) may determine a third disparity for the center pixel of the first region based on the first disparity of the center pixel of the first region and the second disparity of the center pixel of the first region. For example, accumulator 608 of FIG. 6 and/or accumulator 724 of FIG. 7 may determine a disparity based on the disparities determined at block 804 and block 806. For example, accumulator 608 and/or accumulator 724 may select one of the disparities determined at block 804 and block 808 as the third disparity. Minima 510 of FIG. 5 may be examples of minima corresponding to the first disparity and the second disparity (and other disparities) determined for pixel 410 based on comparisons between the cost function of pixel 410 and the cost functions of pixels of regions 506. For example, block 806 may be repeated for any number of regions (e.g., regions 506) including pixel 502. Minimum 516 may be an example of a minimum corresponding to the disparity selected at block 808. In some aspects, block 808 may include determining a median of the determined number of disparities of the center pixel of the first region as the third disparity for the center pixel of the first region. For example, test statistic 514 may select a median of ordered minima 512 as the third disparity.

In some aspects, the computing device (or one or more components thereof) may determine a number of disparities of the center pixel of the first region at least in part by comparing one or more minima of respective cost functions of respective center pixels of a respective number of regions to one or more minima of other respective cost functions of other respective pixels in the number of regions, each region of the number of regions including the center pixel of the first region. Further, block 808 may include determining the third disparity for the center pixel of the first region based on the determined number of disparities of the center pixel of the first region. For example, accumulator 608 and/or accumulator 724 may identify regions 506 and center pixels thereof. Further, accumulator 608 and/or accumulator 724 may compare one or more minima of the cost functions of the respective center pixels with cost functions of the other pixels of the respective regions 506. Because pixel 502 is included in each of regions 506, such a process may determine multiple disparities corresponding to pixel 502. In such cases, block 808 may include selecting one of the determined multiple disparities as the third disparity.

In some aspects, the computing device (or one or more components thereof) may determine depth information for the center pixel of the first region based on the third disparity for the center pixel of the first region. For example, accumulator 724 may determine depth map 726, including a depth corresponding to pixel 410, based on the selected third disparity (e.g., based on a three-dimensional geometry of the image-capture devices and the disparity). For example, accumulator 724 may determine a depth of point P of FIG. 1 using the determined third disparity as disparity d of FIG. 1 based on the offset Tx of FIG. 1.

In some examples, the methods described herein (e.g., method 800 and/or other methods described herein) can be performed by a computing device or apparatus. In one example, one or more of the methods can be performed by system 600 of FIG. 6, classifier 604 of FIG. 6, segmenter 606 of FIG. 6, accumulator 608 of FIG. 6, system 700 of FIG. 7, classifier 716 of FIG. 7, segmenter 720 of FIG. 7, and/or accumulator 724 of FIG. 7. In another example, one or more of the methods can be performed by the computing system 900 shown in FIG. 9. For instance, a computing device with the computing system 900 shown in FIG. 9 can include the components of the system 600 of FIG. 6, and/or the components of system 700 of FIG. 7 and can implement the operations of the method 800 of FIG. 8, and/or other process described herein.

The computing device can include any suitable device, such as a vehicle or a computing device of a vehicle, a mobile device (e.g., a mobile phone), a desktop computing device, a tablet computing device, a wearable device (e.g., a VR headset, an AR headset, AR glasses, a network-connected watch or smartwatch, or other wearable device), a server computer, a robotic device, a television, and/or any other computing device with the resource capabilities to perform the processes described herein, including method 800, and/or other process described herein. In some cases, the computing device or apparatus can include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device can include a display, a network interface configured to communicate and/or receive the data, any combination thereof, and/or other component(s). The network interface can be configured to communicate and/or receive Internet Protocol (IP) based data or other type of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

Method 800 and/or other process described herein are illustrated as logical flow diagrams, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, method 800, and/or other process described herein can be performed under the control of one or more computer systems configured with executable instructions and can be implemented as code (e.g., executable instructions, one or more computer programs, or one or more applications) executing collectively on one or more processors, by hardware, or combinations thereof. As noted above, the code can be stored on a computer-readable or machine-readable storage medium, for example, in the form of a computer program comprising a plurality of instructions executable by one or more processors. The computer-readable or machine-readable storage medium can be non-transitory.

FIG. 9 is a diagram illustrating an example of a system for implementing certain aspects of the present disclosure. In particular, FIG. 9 illustrates an example of computing system 900, which can be for example any computing device making up internal computing system, a remote computing system, a camera, or any component thereof in which the components of the system are in communication with each other using connection 912. Connection 912 can be a physical connection using a bus, or a direct connection into processor 902, such as in a chipset architecture. Connection 912 can also be a virtual connection, networked connection, or logical connection.

In some aspects, computing system 900 can be a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example computing system 900 includes at least one processing unit (CPU or processor) 902 and connection 912 that couples various system components including system memory 910, such as read-only memory (ROM) 908 and random-access memory (RAM) 906 to processor 902. Computing system 900 can include a cache 904 of high-speed memory connected directly with, in close proximity to, or integrated as part of processor 902.

Processor 902 can include any general-purpose processor and a hardware service or software service, such as services 916, 918, and 920 stored in storage device 914, configured to control processor 902 as well as a special-purpose processor where software instructions are incorporated into the actual processor design. Processor 902 can essentially be a completely self-contained computing system, containing multiple cores or processors, a bus, memory controller, cache, etc. A multi-core processor can be symmetric or asymmetric.

To enable user interaction, computing system 900 includes an input device 922, which can represent any number of input mechanisms, such as a microphone for speech, a touch-sensitive screen for gesture or graphical input, keyboard, mouse, motion input, speech, etc. Computing system 900 can also include output device 924, which can be one or more of a number of output mechanisms. In some instances, multimodal systems can enable a user to provide multiple types of input/output to communicate with computing system 900. Computing system 900 can include communication interface 926, which can generally govern and manage the user input and system output. Communication interface 926 can perform or facilitate receipt and/or transmission wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 1540 can also include one or more Global Navigation Satellite System (GNSS) receivers or transceivers that are used to determine a location of the computing system 1500 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 914 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L5/L #), resistive random-access memory (RRAM/ReRAM), phase change memory (PCM), spin transfer torque RAM (STT-RAM), another memory chip or cartridge, and/or a combination thereof.

The storage device 914 can include software services, servers, services, etc., that when the code that defines such software is executed by the processor 902, it causes the system to perform a function. In some aspects, a hardware service that performs a particular function can include the software component stored in a computer-readable medium in connection with the necessary hardware components, such as processor 902, connection 912, output device 924, etc., to carry out the function.

As used herein, the term “computer-readable medium” includes, but is not limited to, portable or non-portable storage devices, optical storage devices, and various other mediums capable of storing, containing, or carrying instruction(s) and/or data. A computer-readable medium can include a non-transitory medium in which data can be stored and that does not include carrier waves and/or transitory electronic signals propagating wirelessly or over wired connections. Examples of a non-transitory medium can include, but are not limited to, a magnetic disk or tape, optical storage media such as compact disk (CD) or digital versatile disk (DVD), flash memory, memory or memory devices. A computer-readable medium can have stored thereon code and/or machine-executable instructions that can represent a procedure, a function, a subprogram, a program, a routine, a subroutine, a module, a software package, a class, or any combination of instructions, data structures, or program statements. A code segment can be coupled to another code segment or a hardware circuit by passing and/or receiving information, data, arguments, parameters, or memory contents. Information, arguments, parameters, data, etc. can be passed, forwarded, or transmitted using any suitable means including memory sharing, message passing, token passing, network transmission, or the like.

In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the aspects and examples provided herein. However, it will be understood by one of ordinary skill in the art that the aspects can be practiced without these specific details. For clarity of explanation, in some instances the present technology can be presented as including individual functional blocks including functional blocks comprising devices, device components, steps or routines in a method embodied in software, or combinations of hardware and software. Additional components can be used other than those shown in the figures and/or described herein. For example, circuits, systems, networks, processes, and other components can be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects can be described above as a process or method which is depicted as a flowchart, a flow diagram, a data flow diagram, a structure diagram, or a block diagram. Although a flowchart can describe the operations as a sequential process, many of the operations can be performed in parallel or concurrently. In addition, the order of the operations can be re-arranged. A process is terminated when its operations are completed, but could have additional steps not included in a figure. A process can correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions can be, for example, binaries, intermediate format instructions such as assembly language, firmware, source code, etc. Examples of computer-readable media that can be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) can be stored in a computer-readable or machine-readable medium. A processor(s) can perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts can be otherwise variously embodied and employed, and that the appended claims are intended to be construed to include such variations, except as limited by the prior art. Various features and aspects of the above-described application can be used individually or jointly. Further, aspects can be utilized in any number of environments and applications beyond those described herein without departing from the scope of the specification. The specification and drawings are, accordingly, to be regarded as illustrative rather than restrictive. For the purposes of illustration, methods were described in a particular order. It should be appreciated that in alternate aspects, the methods can be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

The various illustrative logical blocks, modules, circuits, and algorithm steps described in connection with the aspects disclosed herein can be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans can implement the described functionality in varying ways for each particular application, but such implementation decisions should not be interpreted as causing a departure from the scope of the present application.

The techniques described herein can also be implemented in electronic hardware, computer software, firmware, or any combination thereof. Such techniques can be implemented in any of a variety of devices such as general purposes computers, wireless communication device handsets, or integrated circuit devices having multiple uses including application in wireless communication device handsets and other devices. Any features described as modules or components can be implemented together in an integrated logic device or separately as discrete but interoperable logic devices. If implemented in software, the techniques can be realized at least in part by a computer-readable data storage medium comprising program code including instructions that, when executed, performs one or more of the methods described above. The computer-readable data storage medium can form part of a computer program product, which can include packaging materials. The computer-readable medium can comprise memory or data storage media, such as random-access memory (RAM) such as synchronous dynamic random-access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, can be realized at least in part by a computer-readable communication medium that carries or communicates program code in the form of instructions or data structures and that can be accessed, read, and/or executed by a computer, such as propagated signals or waves.

The program code can be executed by a processor, which can include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor can be configured to perform any of the techniques described in this disclosure. A general-purpose processor can be a microprocessor; but in the alternative, the processor can be any conventional processor, controller, microcontroller, or state machine. A processor can also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the disclosure include:

Aspect 1. An apparatus for determining disparity information, the apparatus comprising: at least one memory; and at least one processor coupled to the at least one memory and configured to: obtain a plurality of cost functions comprising a respective cost function for each pixel of a plurality of pixels of a first image, wherein the respective cost function for each pixel of the plurality of pixels comprises an indication of a similarity, between a window including the pixel and a corresponding window of a second image, as a function of disparity along an epi-polar line in the second image; determine a first disparity for a center pixel of a first region of pixels at least in part by comparing one or more minima of a cost function of the center pixel of the first region to one or more minima of cost functions of other pixels in the first region, the plurality of cost functions comprising the cost function of the center pixel of the first region and the cost functions of the other pixels in the first region; determine a second disparity for the center pixel of the first region at least in part by comparing one or more minima of a cost function of a center pixel of a second region to one or more minima of cost functions of other pixels in the second region, the second region of pixels including the center pixel of the first region, the plurality of cost functions comprising the cost function of the center pixel of the second region and the cost functions of the other pixels in the second region; and determine a third disparity for the center pixel of the first region based on the first disparity of the center pixel of the first region and the second disparity of the center pixel of the first region.

Aspect 2. The apparatus of aspect 1, wherein, in comparing the one or more minima of the cost function of the center pixel of the first region to the one or more minima of the cost functions of the other pixels in the first region, the at least one processor is configured to compare a second minimum of the cost function of the center pixel of the first region to a second minimum of each of the cost functions of the other pixels in the first region.

Aspect 3. The apparatus of any one of aspects 1 or 2, wherein, in identifying the first disparity for the center pixel of the first region of pixels, the at least one processor is configured to identify the first disparity for the center pixel of the first region of pixels based on determining whether a second minimum of each of the cost functions of the other pixels in the first region is less than a second minimum of the cost function of the center pixel of the first region.

Aspect 4. The apparatus of any one of aspects 1 to 3, wherein the at least one processor is further configured to determine a number of disparities of the center pixel of the first region at least in part by comparing one or more minima of respective cost functions of respective center pixels of a respective number of regions to one or more minima of other respective cost functions of other respective pixels in the number of regions, each region of the number of regions including the center pixel of the first region; wherein, in determining the third disparity for the center pixel of the first region, the at least one processor is configured to determine the third disparity for the center pixel of the first region based on the determined number of disparities of the center pixel of the first region.

Aspect 5. The apparatus of aspect 4, wherein, in determining the third disparity for the center pixel of the first region based on the determined number of disparities of the center pixel of the first region, the at least one processor is configured to determine a median of the determined number of disparities of the center pixel of the first region as the third disparity for the center pixel of the first region.

Aspect 6. The apparatus of any one of aspects 1 to 5, wherein the at least one processor is further configured to determine the first region based on determining the center pixel of the first region is associated with an ambiguous cost function based on one or more factors.

Aspect 7. The apparatus of aspect 6, wherein the one or more factors comprise at least one of a cost-difference between lowest minima of the cost function or a disparity-difference between the lowest minima of the cost function.

Aspect 8. The apparatus of any one of aspects 1 to 7, wherein the at least one processor is further configured to determine depth information for the center pixel of the first region based on the third disparity for the center pixel of the first region.

Aspect 9. The apparatus of any one of aspects 1 to 8, further comprising: an illuminator configured to illuminate a scene; a first image sensor configured to capture the first image of the scene; and a second image sensors configured to capture the second image of the scene.

Aspect 10. The apparatus of aspect 9, wherein: the illuminator is configured to illuminate the scene by emitting electromagnetic radiation having a carrier frequency; the at least one processor is further configured to filter the first image using a filter having a passband based on the carrier frequency; and the at least one processor is further configured to filter the second image using the filter.

Aspect 11. A method for determining disparity information, the method comprising: obtaining a plurality of cost functions comprising a respective cost function for each pixel of a plurality of pixels of a first image, wherein the respective cost function for each pixel of the plurality of pixels comprises an indication of a similarity, between a window including the pixel and a corresponding window of a second image, as a function of disparity along an epi-polar line in the second image; determining a first disparity for a center pixel of a first region of pixels at least in part by comparing one or more minima of a cost function of the center pixel of the first region to one or more minima of cost functions of other pixels in the first region, the plurality of cost functions comprising the cost function of the center pixel of the first region and the cost functions of the other pixels in the first region; determining a second disparity for the center pixel of the first region at least in part by comparing one or more minima of a cost function of a center pixel of a second region to one or more minima of cost functions of other pixels in the second region, the second region of pixels including the center pixel of the first region, the plurality of cost functions comprising the cost function of the center pixel of the second region and the cost functions of the other pixels in the second region; and determining a third disparity for the center pixel of the first region based on the first disparity of the center pixel of the first region and the second disparity of the center pixel of the first region.

Aspect 12. The method of aspect 11, wherein comparing the one or more minima of the cost function of the center pixel of the first region to the one or more minima of the cost functions of the other pixels in the first region comprises comparing a second minimum of the cost function of the center pixel of the first region to a second minimum of each of the cost functions of the other pixels in the first region.

Aspect 13. The method any one of aspects 11 or 12, wherein identifying the first disparity for the center pixel of the first region of pixels comprises identifying the first disparity for the center pixel of the first region of pixels based on determining whether a second minimum of each of the cost functions of the other pixels in the first region is less than a second minimum of the cost function of the center pixel of the first region.

Aspect 14. The method of any one of aspects 11 to 13, further comprising determining a number of disparities of the center pixel of the first region at least in part by comparing one or more minima of respective cost functions of respective center pixels of a respective number of regions to one or more minima of other respective cost functions of other respective pixels in the number of regions, each region of the number of regions including the center pixel of the first region; wherein determining the third disparity for the center pixel of the first region comprises determining the third disparity for the center pixel of the first region based on the determined number of disparities of the center pixel of the first region.

Aspect 15. The method of aspect 14, wherein determining the third disparity for the center pixel of the first region based on the determined number of disparities of the center pixel of the first region comprises determining a median of the determined number of disparities of the center pixel of the first region as the third disparity for the center pixel of the first region.

Aspect 16. The method of any one of aspects 11 to 15, further comprising determining the first region based on determining the center pixel of the first region is associated with an ambiguous cost function based on one or more factors.

Aspect 17. The method of aspect 16, wherein the one or more factors comprise at least one of a cost-difference between lowest minima of the cost function or a disparity-difference between the lowest minima of the cost function.

Aspect 18. The method of any one of aspects 11 to 17, further comprising determining depth information for the center pixel of the first region based on the third disparity for the center pixel of the first region.

Aspect 19. The method of any one of aspects 11 to 18, further comprising: illuminating a scene; capturing the first image of the scene at a first image sensor; and capturing the second image of the scene at a second image sensor.

Aspect 20. The method of aspect 19, wherein: illuminating the scene comprises emitting electromagnetic radiation having a carrier frequency; the first image is filtered using a filter having a passband based on the carrier frequency; and the second image is filtered using the filter.

Aspect 21. A non-transitory computer-readable storage medium having stored thereon instructions that, when executed by at least one processor, cause the at least one processor to perform operations according to any of Aspects 11 to 20.

Aspect 22. An apparatus for determining disparity information, the apparatus comprising one or more means for performing operations according to any of Aspects 11 to 20.

What is claimed is:

1. An apparatus for determining disparity information, the apparatus comprising:
at least one memory; and
at least one processor coupled to the at least one memory and configured to:
obtain a plurality of cost functions comprising a respective cost function for each pixel of a plurality of pixels of a first image, wherein the respective cost function for each pixel of the plurality of pixels comprises an indication of a similarity, between a window including the pixel and a corresponding window of a second image, as a function of disparity along an epi-polar line in the second image;
determine a first disparity for a center pixel of a first region of pixels at least in part by comparing one or more minima of a cost function of the center pixel of the first region to one or more minima of cost functions of other pixels in the first region, the plurality of cost functions comprising the cost function of the center pixel of the first region and the cost functions of the other pixels in the first region;
determine a second disparity for the center pixel of the first region at least in part by comparing one or more minima of a cost function of a center pixel of a second region to one or more minima of cost functions of other pixels in the second region, the second region of pixels including the center pixel of the first region, the plurality of cost functions comprising the cost function of the center pixel of the second region and the cost functions of the other pixels in the second region; and
determine a third disparity for the center pixel of the first region based on the first disparity of the center pixel of the first region and the second disparity of the center pixel of the first region.

2. The apparatus of claim 1, wherein, to compare the one or more minima of the cost function of the center pixel of the first region to the one or more minima of the cost functions of the other pixels in the first region, the at least one processor is configured to compare a second minimum of the cost function of the center pixel of the first region to a second minimum of each of the cost functions of the other pixels in the first region.

3. The apparatus of claim 1, wherein, to identify the first disparity for the center pixel of the first region of pixels, the at least one processor is configured to identify the first disparity for the center pixel of the first region of pixels based on determining whether a second minimum of each of the cost functions of the other pixels in the first region is less than a second minimum of the cost function of the center pixel of the first region.

4. The apparatus of claim 1, wherein the at least one processor is further configured to determine a number of disparities of the center pixel of the first region at least in part by comparing one or more minima of respective cost functions of respective center pixels of a respective number of regions to one or more minima of other respective cost functions of other respective pixels in the number of regions, each region of the number of regions including the center pixel of the first region;
wherein, to determine the third disparity for the center pixel of the first region, the at least one processor is configured to determine the third disparity for the center pixel of the first region based on the determined number of disparities of the center pixel of the first region.

5. The apparatus of claim 4, wherein, to determine the third disparity for the center pixel of the first region based on the determined number of disparities of the center pixel of the first region, the at least one processor is configured to determine a median of the determined number of disparities of the center pixel of the first region as the third disparity for the center pixel of the first region.

6. The apparatus of claim 1, wherein the at least one processor is further configured to determine the first region based on determining the center pixel of the first region is associated with an ambiguous cost function based on one or more factors.

7. The apparatus of claim 6, wherein the one or more factors comprise at least one of a cost-difference between lowest minima of the cost function or a disparity-difference between the lowest minima of the cost function.

8. The apparatus of claim 1, wherein the at least one processor is further configured to determine depth information for the center pixel of the first region based on the third disparity for the center pixel of the first region.

9. The apparatus of claim 1, further comprising:
an illuminator configured to illuminate a scene;
a first image sensor configured to capture the first image of the scene; and
a second image sensors configured to capture the second image of the scene.

10. The apparatus of claim 9, wherein:
the illuminator is configured to illuminate the scene by emitting electromagnetic radiation having a carrier frequency;
the at least one processor is further configured to filter the first image using a filter having a passband based on the carrier frequency; and
the at least one processor is further configured to filter the second image using the filter.

11. A method for determining disparity information, the method comprising:
obtaining a plurality of cost functions comprising a respective cost function for each pixel of a plurality of pixels of a first image, wherein the respective cost function for each pixel of the plurality of pixels comprises an indication of a similarity, between a window including the pixel and a corresponding window of a second image, as a function of disparity along an epi-polar line in the second image;
determining a first disparity for a center pixel of a first region of pixels at least in part by comparing one or more minima of a cost function of the center pixel of the first region to one or more minima of cost functions of other pixels in the first region, the plurality of cost functions comprising the cost function of the center pixel of the first region and the cost functions of the other pixels in the first region;
determining a second disparity for the center pixel of the first region at least in part by comparing one or more minima of a cost function of a center pixel of a second region to one or more minima of cost functions of other pixels in the second region, the second region of pixels including the center pixel of the first region, the plurality of cost functions comprising the cost function of the center pixel of the second region and the cost functions of the other pixels in the second region; and
determining a third disparity for the center pixel of the first region based on the first disparity of the center pixel of the first region and the second disparity of the center pixel of the first region.

12. The method of claim 11, wherein comparing the one or more minima of the cost function of the center pixel of the first region to the one or more minima of the cost functions of the other pixels in the first region comprises comparing a second minimum of the cost function of the center pixel of the first region to a second minimum of each of the cost functions of the other pixels in the first region.

13. The method of claim 11, wherein identifying the first disparity for the center pixel of the first region of pixels comprises identifying the first disparity for the center pixel of the first region of pixels based on determining whether a second minimum of each of the cost functions of the other pixels in the first region is less than a second minimum of the cost function of the center pixel of the first region.

14. The method of claim 11, further comprising determining a number of disparities of the center pixel of the first region at least in part by comparing one or more minima of respective cost functions of respective center pixels of a respective number of regions to one or more minima of other respective cost functions of other respective pixels in the number of regions, each region of the number of regions including the center pixel of the first region;
wherein determining the third disparity for the center pixel of the first region comprises determining the third disparity for the center pixel of the first region based on the determined number of disparities of the center pixel of the first region.

15. The method of claim 14, wherein determining the third disparity for the center pixel of the first region based on the determined number of disparities of the center pixel of the first region comprises determining a median of the determined number of disparities of the center pixel of the first region as the third disparity for the center pixel of the first region.

16. The method of claim 11, further comprising determining the first region based on determining the center pixel of the first region is associated with an ambiguous cost function based on one or more factors.

17. The method of claim 16, wherein the one or more factors comprise at least one of a cost-difference between lowest minima of the cost function or a disparity-difference between the lowest minima of the cost function.

18. The method of claim 11, further comprising determining depth information for the center pixel of the first region based on the third disparity for the center pixel of the first region.

19. The method of claim 11, further comprising:
illuminating a scene;
capturing the first image of the scene at a first image sensor; and
capturing the second image of the scene at a second image sensor.

20. The method of claim 19, wherein:
illuminating the scene comprises emitting electromagnetic radiation having a carrier frequency;
the first image is filtered using a filter having a passband based on the carrier frequency; and
the second image is filtered using the filter.

21. A non-transitory computer-readable storage medium having stored thereon instructions that, when executed by at least one processor, cause the at least one processor to:
obtain a plurality of cost functions comprising a respective cost function for each pixel of a plurality of pixels of a first image, wherein the respective cost function for each pixel of the plurality of pixels comprises an indication of a similarity, between a window including the pixel and a corresponding window of a second image, as a function of disparity along an epi-polar line in the second image;
determine a first disparity for a center pixel of a first region of pixels at least in part by comparing one or more minima of a cost function of the center pixel of the first region to one or more minima of cost functions of other pixels in the first region, the plurality of cost functions comprising the cost function of the center pixel of the first region and the cost functions of the other pixels in the first region;
determine a second disparity for the center pixel of the first region at least in part by comparing one or more minima of a cost function of a center pixel of a second region to one or more minima of cost functions of other pixels in the second region, the second region of pixels including the center pixel of the first region, the plurality of cost functions comprising the cost function of the center pixel of the second region and the cost functions of the other pixels in the second region; and
determine a third disparity for the center pixel of the first region based on the first disparity of the center pixel of the first region and the second disparity of the center pixel of the first region.

22. The non-transitory computer-readable storage medium of claim 21, wherein the instructions, when executed by the at least one processor, cause the at least one processor to, in comparing the one or more minima of the cost function of the center pixel of the first region to the one or more minima of the cost functions of the other pixels in the first region, compare a second minimum of the cost function of the center pixel of the first region to a second minimum of each of the cost functions of the other pixels in the first region.

23. The non-transitory computer-readable storage medium of claim 21, wherein, to identifying the first disparity for the center pixel of the first region of pixels, the instructions, when executed by the at least one processor, cause the at least one processor to identify the first disparity for the center pixel of the first region of pixels based on determining whether a second minimum of each of the cost functions of the other pixels in the first region is less than a second minimum of the cost function of the center pixel of the first region.

24. The non-transitory computer-readable storage medium of claim 21, wherein the instructions, when executed by the at least one processor, cause the at least one processor to determine a number of disparities of the center pixel of the first region at least in part by comparing one or more minima of respective cost functions of respective center pixels of a respective number of regions to one or more minima of other respective cost functions of other respective pixels in the number of regions, each region of the number of regions including the center pixel of the first region;
wherein the instructions, when executed by the at least one processor, cause the at least one processor to, in determining the third disparity for the center pixel of the first region, determine the third disparity for the center pixel of the first region based on the determined number of disparities of the center pixel of the first region.

25. The non-transitory computer-readable storage medium of claim 24, wherein, to determine the third disparity for the center pixel of the first region based on the determined number of disparities of the center pixel of the first region, the instructions, when executed by the at least one processor, cause the at least one processor to determine a median of the determined number of disparities of the center pixel of the first region as the third disparity for the center pixel of the first region.

26. The non-transitory computer-readable storage medium of claim 21, wherein the instructions, when executed by the at least one processor, cause the at least one processor to determine the first region based on determining the center pixel of the first region is associated with an ambiguous cost function based on one or more factors.

27. The non-transitory computer-readable storage medium of claim 26, wherein the one or more factors comprise at least one of a cost-difference between lowest minima of the cost function or a disparity-difference between the lowest minima of the cost function.

28. The non-transitory computer-readable storage medium of claim 21, wherein the instructions, when executed by the at least one processor, cause the at least one processor to determine depth information for the center pixel of the first region based on the third disparity for the center pixel of the first region.

29. An apparatus for determining disparity information, the apparatus comprising:
means for obtaining a plurality of cost functions comprising a respective cost function for each pixel of a plurality of pixels of a first image, wherein the respective cost function for each pixel of the plurality of pixels comprises an indication of a similarity, between a window including the pixel and a corresponding window of a second image, as a function of disparity along an epi-polar line in the second image;
means for determining a first disparity for a center pixel of a first region of pixels at least in part by comparing one or more minima of a cost function of the center pixel of the first region to one or more minima of cost functions of other pixels in the first region, the plurality of cost functions comprising the cost function of the center pixel of the first region and the cost functions of the other pixels in the first region;
means for determining a second disparity for the center pixel of the first region at least in part by comparing one or more minima of a cost function of a center pixel of a second region to one or more minima of cost functions of other pixels in the second region, the second region of pixels including the center pixel of the first region, the plurality of cost functions comprising the cost function of the center pixel of the second region and the cost functions of the other pixels in the second region; and
means for determining a third disparity for the center pixel of the first region based on the first disparity of the center pixel of the first region and the second disparity of the center pixel of the first region.

30. The apparatus of claim 29, wherein comparing the one or more minima of the cost function of the center pixel of the first region to the one or more minima of the cost functions of the other pixels in the first region comprises comparing a second minimum of the cost function of the center pixel of the first region to a second minimum of each of the cost functions of the other pixels in the first region.
